(19) United States
(12) Patent Application Publication
(10) Pub. No.: US 2008/0008963 A1
(43) Pub. Date: Jan. 10, 2008

(54) Reversible heat-sensitive recording medium and method of recording an image using the heat-sensitive recording medium

(75) Inventors: Toshiyuki Tamura, Mishima (JP); Takayuki Hiyoshi, Sunto (JP); Kazunori Murakami, Izunokuni (JP); Yoshimitsu Ohtaka, Sunto (JP)

Correspondence Address: HARNESS, DICKEY & PIERCE, P.L.C., P.O. BOX 828, BLOOMFIELD HILLS, MI, 48303, US

(73) Assignee: Toshiba Tec Kabushiki Kaisha

(21) Appl. No.: 11/825,632

(22) Filed: Jul. 6, 2007

(30) Foreign Application Priority Data
Jul. 10, 2006 (JP) 2006-189630
Jun. 21, 2007 (JP) 2007-163375

(51) Int. Cl. G03C 1/00; G03C 5/16

(52) U.S. Cl. 430/270.1; 430/348

(57) ABSTRACT

A reversible heat-sensitive recording medium is provided, which includes a heat-sensitive portion, and a light-transmitting heat-insulating layer disposed to contact the heat-sensitive portion. The heat-sensitive portion contains a light-heat conversion material and a heat-sensitive reversible layer. The light-heat conversion material is enabled to absorb light having a specific wavelength and to convert the light into heat energy. The heat-sensitive reversible layer contains an electron-donating coloring compound and an electron-accepting compound and is enabled to change from a decolorized state to a color-developed state and vice versa, depending on difference in heating temperature and/or cooling temperature to be effected after heating. The light-transmitting heat-insulating is capable of transmitting light having the specific wavelength which the light-heat conversion material is enabled to absorb and also capable of insulating the heat to be emitted from the light-heat conversion material.

### CROSS-REFERENCE TO RELATED APPLICATIONS

This application is based upon and claims the benefit of priority from prior Japanese Patent Applications No. 2006-189630, filed Jul. 10, 2006; and No. 2007-163375, filed Jun. 21, 2007, the entire contents of both of which are incorporated herein by reference.

### BACKGROUND OF THE INVENTION

1. Field of the Invention

This invention relates to a reversible heat-sensitive recording medium which is capable of recording an image in a noncontacting manner by light and also capable of erasing the image. This invention also relates to a method of recording an image using such a recording medium.

2. Description of the Related Art

As a reversible heat-sensitive recording medium which is capable of recording an image in a noncontacting manner using light and also capable of erasing the image, there has been conventionally known a structure wherein a light-heat conversion layer, a reversible heat-sensitive recording layer and a light-heat conversion layer are successively laminated on a supporting body formed from polyethylene terephthalate, paper, etc. In this case, the light-heat conversion layer comprises a light-heat conversion material as a major component and the reversible heat-sensitive recording layer usually comprises a colorless or light-colored leuco dye, and a reversible color-developing agent which is capable of developing the leuco dye as it is heated and also capable of decolorizing the leuco dye as it is re-heated.

There has been also known a structure wherein a first recording layer, a second recording layer and a third recording layer are successively laminated on a substrate with a heat insulating barrier being interposed between these layers, and a protective layer is deposited on an uppermost layer. Each of these recording layers is constituted by a material which can be controlled so as to take a decolorized state or a color-developed state, thereby enabling a stable repetition of recording. Further, these recording layers respectively contain a light-heat conversion material which is enabled to develop heat as it absorbs infrared rays having a specific wavelength differing from others.

### BRIEF SUMMARY OF THE INVENTION

The relationship between optical energy to be emitted and recording speed is an issue in the recording of an image is to be applied to a reversible heat-sensitive recording medium in a noncontacting manner by light. When a semiconductor laser is employed as the light for writing, it would be possible to obtain advantages that a writing device can be miniaturized and manufactured at lower cost but the light energy that can be derived from the semiconductor laser is relatively low. For this reason, the conventional reversible heat-sensitive recording medium is accompanied with problems that the efficiency of converting a given light energy into heat is relatively low so that it is impossible to sufficiently develop the heat required for the recording of an image unless the speed of a laser beam during scanning is sufficiently decreased.

Therefore, objects of the present invention are to provide a reversible heat-sensitive recording medium which is capable of effectively converting a given light energy into heat in the photothermal recording, thereby making it possible to realize faster image-recording and also provide a method of recording an image using such a recording medium.

A reversible heat-sensitive recording medium according to one aspect of the present invention comprises a heat-sensitive portion containing a light-heat conversion material and a heat-sensitive reversible layer, the light-heat conversion material being enabled to absorb light having a specific wavelength and to convert the light into heat energy and the heat-sensitive reversible layer containing an electron-donating coloring compound and an electron-accepting compound and being enabled to change from a decolorized state to a color-developed state and vice versa, depending on difference in heating temperature and/or cooling temperature to be effected after heating; and a light-transmitting heat-insulating layer disposed to contact the heat-sensitive portion, the light-transmitting heat-insulating layer being capable of transmitting light having the specific wavelength which the light-heat conversion material is enabled to absorb and also capable of insulating the heat to be emitted from the light-heat conversion material.

A method of recording an image according to one aspect of the present invention comprises recording an image on a reversible heat-sensitive recording medium comprising a light-transmitting substrate, on which a light-transmitting heat-insulating layer, a heat-sensitive reversible layer and a second light-transmitting heat-insulating layer are successively deposited, wherein the recording of the image is effected through irradiation of a laser beam having a specific wavelength to the opposite sides of the recording medium to enable the laser beam to be absorbed and converted by the light-heat conversion material into thermal energy, by which the heat-sensitive reversible layer is caused to develop a color.

A method of recording an image according to another aspect of the present invention comprises recording an image on a reversible heat-sensitive recording medium comprising a light-transmitting substrate, on which a light-transmitting heat-insulating layer, a light-heat conversion layer, a heat-sensitive reversible layer, a second light-heat conversion layer and a second light-transmitting heat-insulating layer are successively deposited, wherein the recording of the image is effected through irradiation of a laser beam having a specific wavelength to the opposite sides of the recording medium to enable the laser beam to be absorbed and converted by the light-heat conversion material into thermal energy, by which the heat-sensitive reversible layer is caused to develop a color.

### BRIEF DESCRIPTION OF THE SEVERAL VIEWS OF THE DRAWING

FIG. 1 is a cross-sectional view showing the structure of the reversible heat-sensitive recording medium according to a first embodiment;

FIG. 2 is a cross-sectional view showing the structure of the reversible heat-sensitive recording medium according to a second embodiment;

FIG. 3 is a cross-sectional view showing the structure of the reversible heat-sensitive recording medium according to a third embodiment;

FIG. 4 is a cross-sectional view showing the structure of the reversible heat-sensitive recording medium according to a fourth embodiment;

FIG. 5 is a cross-sectional view showing the structure of the reversible heat-sensitive recording medium according to a fifth embodiment;

FIG. 6 is a cross-sectional view showing the structure of the reversible heat-sensitive recording medium according to a sixth embodiment; and

FIG. 7 is a cross-sectional view showing a state recorded of an image which was formed on the reversible heat-sensitive recording medium according to a seventh embodiment.

### DETAILED DESCRIPTION OF THE INVENTION

Next, various embodiments of the present invention will be explained with reference to drawings. In the first, second, third, fourth, fifth and sixth embodiments, there are discussed about the constructions of various kinds of reversible heat-sensitive recording medium. In the seventh embodiment, a method of recording an image using these reversible heat-sensitive recording media is explained.

### First Embodiment

In the case of the reversible heat-sensitive recording medium 100, a heat-sensitive reversible layer 3 is deposited, via a heat-insulating layer 2, on a substrate 1. The heat-insulating layer 2 is not essential and hence may be omitted.

The heat-sensitive reversible layer 3 is constituted by a light-heat conversion material which is capable of developing heat as it absorbs light having a wavelength of near-infrared rays representing a light having specific wavelength (e.g., 808 nm), a leuco dye representing an electron-donating coloring compound, and a color-developing/tone-reducing agent representing an electron-accepting compound. This heat-sensitive reversible layer 3 is enabled to change from a decolorized state to a color-developed state and vice versa, depending on difference in heating temperature and/or cooling temperature to be effected after heating.

A heat-sensitive reversible layer containing a light-heat conversion material is herein referred to as a heat-sensitive portion. Under a certain circumstance, the light-heat conversion material may be incorporated in a layer other than the heat-sensitive reversible layer. For example, the light-heat conversion material may be included in a light-heat conversion layer to create a heat-sensitive portion which is constituted by this light-heat conversion layer and the heat-sensitive reversible layer. The heat-sensitive portion constructed in this manner will be explained hereinafter.

As the leuco dye, it is possible to employ, but not limited thereto, for example a fluoran-based compound, a triphenyl methane-based compound, a fluorene-based compound. As the color-developing/tone-reducing agent, it is possible to employ any kinds of compound which are capable of bringing about reversible changes in color tone of the leuco dye as the compound is heated.

As the substrate 1, it is possible to employ a substrate made of paper or plastics. In the case where a paper substrate is to be employed, it is more preferable to employ one which is more excellent in surface smoothness. The reason for this is that if the surface of paper substrate is roughened, non-uniformity in concentration of color is liable to generate on the surface of paper as the paper is brought into a color-developed state or into a decolorized state. Further, when the thickness of paper substrate is increased, the color development or decolorization may be badly affected by moisture. In order to avoid such a problem, the thickness of paper should preferably be confined to the same with or somewhat higher than the thickness of material to be coated on the surface of paper.

As the plastic substrate, it is possible to employ polyethylene terephthalate (PET), polybutylene terephthalate, poly-1,4-cyclohexanedimethylene terephthalate, polyxylylene terephthalate, polyethylene isophthalate, polyethylene-2,6-naphthalate (PEN), etc. Among them, the employment of PET or PEN is more preferable in terms of toughness, heat resistance, chemical resistance, transparency, etc.

The heat-insulating layer 2 may contain an inorganic material such as sintered kaolin, porous silica, calcium carbonate, etc., or hollow particles of resinous materials such as polystyrene, crosslinked styrene-acrylic resin, etc. These materials may be employed together with a binder resin. As the binder resin, it is possible to employ polyester resin, polyvinyl alcohol, vinyl chloride resin, styrene-butadiene resin, etc. As for the thickness of coating, it should preferably be confined within the range of 2-50 μm or so. Incidentally, if the thickness of coating is too thin, the effect thereof as a heat-insulating layer may become insufficient. On the other hand, if the thickness of coating is higher than 50 μm, the number of repeated use of the reversible heat-sensitive recording medium would be badly restricted. The heat-insulating layer 2 may contain a brightening agent in order to enhance the whiteness thereof.

The light-heat conversion material to be incorporated into the heat-sensitive reversible layer 3 is selected from those which are hardly capable of absorbing visible light and are capable of absorbing the light of the near-infrared region. As the materials which are suited for use in connection with a semiconductor laser emitting near-infrared rays for example, it is possible to employ those which are capable of fully absorbing light having a wavelength ranging from about 780 to 850 nm and capable of converting the light into heat. More specifically, it is possible to employ, as the light-heat conversion material, cyanine-based materials, polymethine-based materials, phthalocyanine-based materials, naphthalocyanine-based materials, etc. When employing the light-heat conversion material, it is dissolved or finely dispersed in a binder resin.

As the binder resin, either a thermoplastic resin or a thermosetting can be employed.

As the thermoplastic resin, it is possible to employ, for example, ethylene-vinyl chloride copolymer, ethylene-vinyl acetate copolymer, ethylene-vinyl acetate-vinyl chloride copolymer, vinylidene chloride resin, vinyl chloride resin, chlorinated polypropylene resin, chlorinated vinyl chloride resin, chlorinated polyethylene resin, vinyl acetate resin, phenoxy resin, butadiene resin, petroleum resin, fluorinated resin, polyamide resin, polyimide resin, polyamide-imide resin, polyacrylate resin, polyether imide resin, polyether ketone, polyethylene, polyethylene oxide, polycarbonate, polycarbonate styrene, polysulfone, polyparamethyl styrene, polyalyl amine, polyvinyl alcohol, modified polyvinyl alcohol, polyvinyl ether, polyvinyl butyral, polyvinyl acetal, polyvinyl formal, polyphenylene ether polypropylene, polymethyl pentene, methacryl resin, acryl resin, etc. As the thermosetting resin, it is possible to employ, for example, epoxy resin, xylene resin, guanamine resin, diallylphthalate resin, vinyl ester resin, phenol resin, unsaturated polyester resin, furan resin, polyimide, polyurethane, maleic resin, melamine resin, urea resin, etc. These binder resins may be respectively polymerized or mixed together before use.

In order to form the heat-sensitive reversible layer 3, a light-heat conversion material is dissolved in a solvent to form a coating liquid, which is subsequently employed for coating. As the solvent useful in this case, it is possible to employ water; alcohols such as methanol, ethanol, isopropyl alcohol, n-butanol, etc.; ketones such as acetone, 2-butanone, etc.; glycol esters; esters such as ethyl acetate, methyl acetate, etc.; cyclohexanone; etc. These light-heat conversion materials are respectively dissolved in a solvent and then subjected to fine dispersion treatment using a dispersion mixer such as a paint shaker, a ball mill, a sand mill, etc., to obtain a coating liquid. The fine dispersion may be performed after the preliminary dispersion of the components.

As the method of coating the heat-sensitive reversible layer 3, there is not any particular limitation. It is possible to perform the coating by an air-knife, a wire bar, gravure coating, kiss coating, die coating, microgravure coating, etc. Using these methods, the coating liquid is coated generally at a thickness of 5-15 μm on the heat-insulating layer or on the substrate, thereby forming the heat-sensitive reversible layer 3.

On this heat-sensitive reversible layer 3 is then deposited a light-transmitting heat-insulating layer 4 containing hollow particles whose particle diameter is smaller than the wavelength of the near-infrared rays to be irradiated. The hollow particles are employed for preventing the heat of light-heat conversion material from escaping upward. The light-transmitting heat-insulating layer 4 may further contain a macromolecular ultraviolet absorbent.

The light-transmitting heat-insulating layer 4 contains, as a major component, a material which is capable of transmitting the wavelength of near-infrared rays and is excellent in heat-insulating property. As for examples of such a material, they include hollow particles formed from polystyrene, styrene-acrylic resin, etc. An average particle diameter of the hollow particles should preferably be not larger than the absorption wavelength of the light-heat conversion material to be employed, more preferably about a half of the absorption wavelength. If the average particle diameter of the hollow particles is too small, the effect of insulating heat would be deteriorated and hence it is preferable to employ hollow particles having an average particle diameter ranging from 0.2 to 0.5 μm.

The hollow particles, the aforementioned binder resin and the ultraviolet absorbent are dispersed in a solvent which does not give any damage to the hollow particles such as water and alcohol to obtain a coating liquid. This coating liquid is then coated on the heat-sensitive reversible layer 3 by the aforementioned coating method to form the light-transmitting heat-insulating layer 4. As the ultraviolet absorbent, it is possible to employ a macromolecular benzophenone-based compound, a macromolecular benzotriazole-based compound, etc. If the ultraviolet absorbent to be employed is insoluble in a solvent, an emulsion of the ultraviolet absorbent may be employed instead. As the particle diameter of the emulsion to be employed as an ultraviolet absorbent, it should preferably be confined, as in the case of the light-heat conversion material, to the range of 0.2 to 0.5 μm.

In order to protect the light-transmitting heat-insulating layer 4 from being affected by external environments, a protective layer 5 containing, for example, a water-proofing resin as a major component is formed on the light-transmitting heat-insulating layer 4. This protective layer 5 is not essential and may be provided if required. As for the film thickness of the protective layer 5, there is not any particular limitation and hence can be optionally determined within the range which does not obstruct the irradiation of near-infrared rays. As for the coating method and the resin to be employed in the formation of the protective layer 5, the same methods and resins as employed in the formation of the heat-sensitive reversible layer 3 can be employed.

In the reversible heat-sensitive recording medium 100 constructed in this manner, near-infrared rays, for example, a semiconductor laser beam of the near-infrared region that has passed through the protective layer 5, are enabled to reach the heat-sensitive reversible layer 3 after passing through the light-transmitting heat-insulating layer 4. In this heat-sensitive reversible layer 3, the laser beam is converted into heat by the effect of the light-heat conversion material. The heat thus generated is entrapped between the heat-insulating layer 2 formed below the heat-sensitive reversible layer 3 and the light-transmitting heat-insulating layer 4 formed on the heat-sensitive reversible layer 3, thus preventing the heat from being diffused. As a result, it is now possible to effectively utilize the heat in the interior of the heat-sensitive reversible layer 3.

In this manner, the laser beam can be effectively converted into heat, and the leuco dye in the heat-sensitive reversible layer 3 is enabled to develop the color thereof. Accordingly, it is now possible to perform the recording of images even if the irradiation of the laser beam is limited to a short time. Further, it is now possible, through the employment of this reversible heat-sensitive recording medium 100, to speed up the recording of images by the laser beam scanning.

### Second Embodiment

In this embodiment, the same portions or parts as those of the previous embodiment will be identified by the same reference symbols, thereby omitting detailed explanation thereof.

In the reversible heat-sensitive recording medium 101 shown in FIG. 2, a heat-sensitive reversible layer 13 is deposited, via a heat-insulating layer 2, on a substrate 1. The heat-insulating layer 2 is not essential and hence can be omitted.

This heat-sensitive reversible layer 13 contains a leuco dye representing an electron-donating coloring compound, and a color-developing/tone-reducing agent representing an electron-accepting compound. This heat-sensitive reversible layer 13 is enabled to change from a color-developing state into a decolorized state and vice versa depending on difference in heating temperature and/or cooling temperature to be effected after heating.

On this heat-sensitive reversible layer 13 are successively deposited a light-heat conversion layer 6 containing a light-heat conversion material, a light-transmitting heat-insulating layer 4 and a protective layer 5. The light-heat conversion material is capable of developing heat as it absorbs light having a wavelength of near-infrared rays representing a light of specific wavelength, for example, light having a wavelength of 808 nm. In this embodiment, the heat sensitive portion is constituted by the heat-sensitive reversible layer 13 and the light-heat conversion layer 6.

In the reversible heat-sensitive recording medium 101 constructed in this manner, near-infrared rays, for example, a semiconductor laser beam of the near-infrared region that has passed through the protective layer 5, are enabled to reach the light-heat conversion layer 6 after passing-through the light-transmitting heat-insulating layer 4. In this light-heat conversion layer 6, the laser beam is converted into heat by the effect of the light-heat conversion material. Although the heat thus generated can be transmitted to the heat-sensitive reversible layer 13, but cannot be transmitted to an upper portion of the reversible heat-sensitive recording medium as the transmission of the heat is obstructed by the light-transmitting heat-insulating layer 4, thus preventing the diffusion of heat. As a result, it is now possible to effectively utilize the heat in the interior of the heat-sensitive reversible layer 13.

In this manner, the laser beam can be effectively converted into heat and the leuco dye in the heat-sensitive reversible layer 13 is enabled to develop the color thereof. Accordingly, it is now possible to perform the recording of images even if the irradiation of the laser beam is limited to a short time. Further, it is now possible, through the employment of this reversible heat-sensitive recording medium 101, to speed up the recording of images by the laser beam scanning.

### Third Embodiment

In this embodiment, the same portions or parts as those of the previous embodiment will be identified by the same reference symbols, thereby omitting detailed explanation thereof.

In the reversible heat-sensitive recording medium 102 shown in FIG. 3, a light-transmitting heat-insulating layer 4, a heat-sensitive reversible layer 3 containing a light-heat conversion material, and a protective layer 15 are successively deposited on a transparent substrate 11 which is formed of a light-transmitting material. This transparent substrate 11 may be formed of PET or PEN. In this embodiment, the heat-sensitive reversible layer 3 containing a light-heat conversion material corresponds to the heat-sensitive portion.

In the reversible heat-sensitive recording medium 102 constructed in this manner, near-infrared rays, for example, a semiconductor laser beam of the near-infrared region that has passed through the transparent substrate 11, are enabled to reach the heat-sensitive reversible layer 3 after passing through the light-transmitting heat-insulating layer 4. In this heat-sensitive reversible layer 3, the laser beam is converted into heat by the effect of the light-heat conversion material. Further, the heat thus generated is prevented from diffusing as it is obstructed by the light-transmitting heat-insulating layer 4. Although the protective layer 15 is not so excellent in heat-insulating property, the light-transmitting heat-insulating layer 4 is interposed between the heat-sensitive reversible layer 3 and the transparent substrate, thus making it possible to effectively utilize the heat in the interior of the heat-sensitive reversible layer 3.

In this manner, the laser beam can be effectively converted into heat and the leuco dye in the heat-sensitive reversible layer 3 is enabled to develop the color thereof. Accordingly, it is now possible to perform the recording of images even if the irradiation of the laser beam is limited to a short time. Further, it is now possible, through the employment of this reversible heat-sensitive recording medium 102, to speed up the recording of images by the laser beam scanning.

### Fourth Embodiment

In this embodiment, the same portions or parts as those of the previous embodiment will be identified by the same reference symbols, thereby omitting detailed explanation thereof.

In the reversible heat-sensitive recording medium 103 shown in FIG. 4, a light-transmitting heat-insulating layer 4, a light-heat conversion layer 6, a heat-sensitive reversible layer 13, and a protective layer 15 are successively deposited on a transparent substrate 11. This heat-sensitive reversible layer 13 contains a leuco dye representing an electron-donating coloring compound, and a color-developing/tone-reducing agent representing an electron-accepting compound. In this embodiment, the heat sensitive portion is constituted by the light-heat conversion layer 6 and the heat-sensitive reversible layer 13.

In the reversible heat-sensitive recording medium 103 constructed in this manner, near-infrared rays, for example, a semiconductor laser beam of the near-infrared region that has passed through the transparent substrate 11, are enabled to reach the light-heat conversion layer 6 after passing through the light-transmitting heat-insulating layer 4. In this light-heat conversion layer 6, the laser beam is converted into heat by the effect of the light-heat conversion material. Although the heat thus generated can be transmitted to the heat-sensitive reversible layer 13 formed at an upper portion of the reversible heat-sensitive recording medium, the heat is prevented from diffusing into a lower portion of the reversible heat-sensitive recording medium as it is obstructed by the light-transmitting heat-insulating layer 4, thus preventing the diffusion of heat. Although the protective layer 15 is not so excellent in heat-insulating property, the light-transmitting heat-insulating layer 4 is interposed between the light-heat conversion layer 6 and the transparent substrate, thus making it possible to effectively utilize the heat in the interior of the heat-sensitive reversible layer 13. In this manner, the heat-generated in the light-heat conversion layer 6 can be effectively utilized in the interior of the heat-sensitive reversible layer 13.

In this manner, the laser beam can be effectively converted into heat and the leuco dye in the heat-sensitive reversible layer 13 is enabled to develop the color thereof. Accordingly, it is now possible to perform the recording of images even if the irradiation of the laser beam is limited to a short time. Further, it is now possible, through the employment of this reversible heat-sensitive recording medium 103, to speed up the recording of images by the laser beam scanning.

### Fifth Embodiment

In this embodiment, the same portions or parts as those of the previous embodiment will be identified by the same reference symbols, thereby omitting detailed explanation thereof.

In the reversible heat-sensitive recording medium 104 shown in FIG. 5, a light-transmitting heat-insulating layer 4, a heat-sensitive reversible layer 23, a second light-transmitting heat-insulating layer 7, and a protective layer 5 are successively deposited on a transparent substrate 11 formed of a light-transmitting material.

This heat-sensitive reversible layer 23 contains a light-heat conversion material which is capable of absorbing light having a wavelength of near-infrared rays representing light having a specific wavelength and hence capable of generating heat, a leuco dye representing an electron-donating coloring compound, and a color-developing/tone-reducing agent representing an electron-accepting compound. The second light-transmitting heat-insulating layer 7 contains hollow particles and a macromolecular ultraviolet-absorbing material. The hollow particles are smaller in particle diameter than the wavelength of near-infrared rays to be irradiated, thereby preventing the heat of light-heat conversion material from escaping upward. In this embodiment, the heat-sensitive reversible layer 23 containing a light-heat conversion material corresponds to the heat-sensitive portion.

In the reversible heat-sensitive recording medium 104 constructed as described above, near-infrared rays, such as a semiconductor laser beam of the near-infrared region, are irradiated to the recording medium through both sides, i.e., the transparent substrate 11 and the protective layer 5. The semiconductor laser beam that has passed through the transparent substrate 11 is enabled to reach the heat-sensitive reversible layer 23 after passing through the light-transmitting heat-insulating layer 4. The semiconductor laser beam that has passed through the protective layer 5 is enabled to reach the heat-sensitive reversible layer 23 after passing through the second light-transmitting heat-insulating layer 7. In this heat-sensitive reversible layer 23, the laser beam is converted into heat by the effect of the light-heat conversion material. This heat is prevented from diffusing due the existence of the light-transmitting heat-insulating layer 4 which is disposed below the heat-sensitive reversible layer 23 and also due to the existence of the second light-transmitting heat-insulating layer 7 which is disposed above the heat-sensitive reversible layer 23. As a result, the heat is entrapped inside the heat-sensitive reversible layer 23, thus making it possible to effectively utilize the heat.

In this manner, the laser beam thus irradiated through both sides can be effectively converted into heat and the leuco dye in the heat-sensitive reversible layer 23 is enabled to develop the color thereof. Moreover, as long as the powers of the laser beams to be irradiated through both sides are the same as each other, the total power of the laser beam to be irradiated to the recording medium can be almost doubled. Using a pair of laser beams in this manner in the irradiation of the recording medium, it is possible to achieve the recording of images even if the irradiation time of the laser beam is very short. Therefore, it is possible, through the employment of this reversible heat-sensitive recording medium 104, to further enhance the recording speed of images by the laser beam scanning.

### Sixth Embodiment

In this embodiment, the same portions or parts as those of the previous embodiment will be identified by the same reference symbols, thereby omitting detailed explanation thereof.

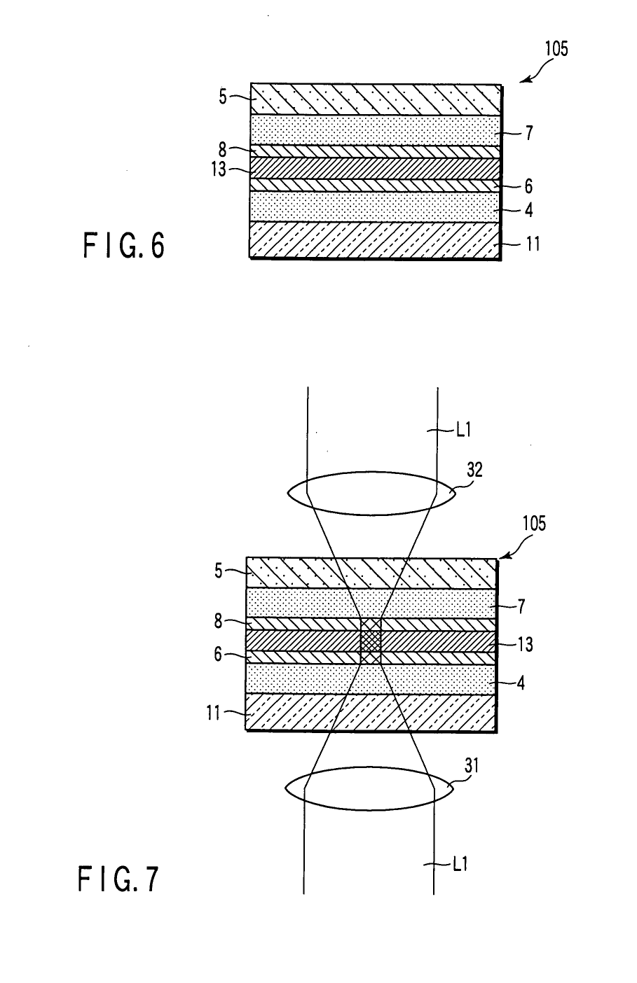

In the reversible heat-sensitive recording medium 105 shown in FIG. 6, a light-transmitting heat-insulating layer 4, a light-heat conversion layer 6, a heat-sensitive reversible layer 13, a second light-heat conversion layer 8, a light-transmitting heat-insulating layer 7, and a protective layer 5 are successively deposited on a transparent substrate 11. The second light-heat conversion layer 8 contains a light-heat conversion material which is capable of absorbing light having a wavelength of near-infrared rays representing light having a specific wavelength and hence capable of generating heat. In this embodiment, the heat-sensitive layer is constituted by the light-heat conversion layer 6, the heat-sensitive reversible layer 13, and the second light-heat conversion layer 8.

In the reversible heat-sensitive recording medium 105 constructed as described above, near-infrared rays, for example, a semiconductor laser beam of the near-infrared region, are irradiated to the recording medium through both sides, i.e., the transparent substrate 11 and the protective layer 5. The semiconductor laser beam irradiated through the transparent substrate 11 is permitted to reach the light-heat conversion layer 6 through the light-transmitting heat-insulating layer 4. In this light-heat conversion layer 6, the light is converted into heat by the effects of the light-heat conversion material.

Further, the semiconductor laser beam irradiated through the protective layer 5 is permitted to reach the second light-heat conversion layer 8 through the second light-transmitting heat-insulating layer 7. In this second light-heat conversion layer 8, the light is converted into heat by the effects of the light-heat conversion material.

Heat is applied to the heat-sensitive reversible layer 13 from these light-heat conversion layers 6 and 8 which are disposed on the opposite sides of the heat-sensitive reversible layer 13. The heat of the light-heat conversion layer 6 is prevented from diffusing by the light-transmitting heat-insulating layer 4 which is disposed below the light-heat conversion layer 6, the heat of the light-heat conversion layer 8 is prevented from being diffused by the second light-transmitting heat-insulating layer 7 which is disposed above the light-heat conversion layer 8. Accordingly, the heat existing in the interior of the heat-sensitive reversible layer 13 can be entrapped therein and made available for effective use thereof.

In this manner, the laser beam thus irradiated through both sides can be effectively converted into heat and the leuco dye in the heat-sensitive reversible layer 13 is enabled to develop the color thereof. Moreover, as long as the powers of the laser beams to be irradiated through both sides are the same as each other, the total power of the laser beam to be irradiated to the recording medium can be almost doubled. Using a pair of laser beams in this manner in the irradiation of the recording medium, it is possible to achieve the recording of images even if the irradiation time of the laser beam is very short. Therefore, it is possible, through the employment of this reversible heat-sensitive recording medium 105, to further enhance the recording speed of images by the laser beam scanning.

### Seventh Embodiment

In this embodiment, there will be described a method of recording images using a reversible heat-sensitive recording medium. As the reversible heat-sensitive recording medium, the reversible heat-sensitive recording medium 105 of Sixth Embodiment is employed.

As shown in FIG. 7, using a first laser optical system 31, a semiconductor laser L1 is irradiated from the transparent substrate 11 side and, at the same time, using a second laser optical system 32, a semiconductor laser L2 is irradiated from the protective layer 5 side, thereby performing the recording of images.

The heat to be generated from the light-heat conversion material which is included in the light-heat conversion layers 6 and 8 disposed on the opposite sides of the heat-sensitive reversible layer 13 is substantially proportional to the light energy to be irradiated. Accordingly, when a pair of laser beams L1 and L2 are concurrently irradiated to the same position of pixel from the opposite sides of the reversible heat-sensitive recording medium 105, the time required for forming one pixel can be reduced to a half. Namely, it is possible to speed up the recording of images. Further, if it is desired to record images taking the same time period as required when a single laser beam is used, the power of each laser beam can be reduced to a half as compared with the case where a single laser is used.

If it is difficult, from the structural viewpoint of the optical system, to apply the irradiation of a laser beam to the same portion of the recording medium using a pair of laser beams L1 and L2; these laser beams may be irradiated to different portions of the recording medium in the scanning of these laser beams.

Since a laser optical system of such a construction would lead to an increase of size comparatively, it would become difficult to position the laser optical system at a position which is close to the reversible heat-sensitive recording medium. Whereas, when the reversible heat-sensitive recording medium 105 of this embodiment is employed, it would become possible to effectively convert light into heat, thus making it possible to minimize the configuration of optical system and to alleviate any restriction when installing such an optical system.

Next, there will be explained about specific examples where various kinds of reversible heat-sensitive recording media constructed as described in the aforementioned embodiments as well as comparative example differing in construction from the aforementioned embodiments.

First of all, various kinds of coating liquids employed in these examples will be explained.

Two kinds of liquid, i.e., A1 liquid and A2 liquid, were prepared as a coating liquid for forming the heat-insulating layer.

The A1 liquid was a coating liquid for forming the light-shielding heat-insulating layer and was obtained by dispersing the following components in a paint shaker for 10 hours.

KOKAL (sintered kaolin: Shiraishi Calcium Co., Ltd.) as pigment—25 parts by weight

PVA318 as a binder resin—8 parts by weight

Water as a solvent—75 parts by weight

The A2 liquid was a coating liquid for forming the heat-insulating layer formed through the employment of hollow particles and was obtained by dispersing the following components in a paint shaker for 10 hours.

M-600 (Matsumoto Yushi Seiyaku Co., Ltd.) as pigment—16 parts by weight

Daiferamine 5022 (Dainichi Seika Industries Co., Ltd.) as a binder resin—14 parts by weight

MEK as a solvent—80 parts by weight

Two kinds of liquid, i.e., B1 liquid and B2 liquid, were prepared as a coating liquid for forming the heat-sensitive reversible layer.

The B1 liquid was a coating liquid for forming the heat-sensitive reversible layers 3 and 23 both containing a light-heat conversion material and was obtained by dispersing the following components together with glass beads in a paint shaker for 24 hours.

ODB-2 (Yamamoto Kasei Co., Ltd.) as an electron-donating coloring compound—2 parts by weight

N-(p-hydroxyphenyl)-N′-n-dodecyl urea as an electron-accepting compound (a color-developing/tone-reducing agent)—8 parts by weight

SDA 1816 (H.W. Sands Co., Ltd.) as a light-heat conversion material—2 parts by weight

Vinyl chloride-vinyl acetate copolymer as a binder resin—20 parts by weight

MEK as a solvent—150 parts by weight

The B2 liquid was a coating liquid for forming the heat-sensitive reversible layer 13 containing no light-heat conversion material and was obtained by dispersing the following components together with glass beads in a paint shaker for 24 hours.

ODB-2 (Yamamoto Kasei Co., Ltd.) as an electron-donating coloring compound—2 parts by weight

N-[5-(p-hydroxyphenyl carbamoyl)pentyl]-n-n-octadecyl urea as an electron-accepting compound (a color-developing/tone-reducing agent)—8 parts by weight

Vinyl chloride-vinyl acetate copolymer as a binder resin—20 parts by weight

Toluene as a solvent—150 parts by weight

One kind of liquid, i.e., C liquid was prepared as a coating liquid for forming the light-heat conversion layer.

The C liquid was a coating liquid for forming the light-heat conversion layers 6 and 8 and was obtained by dispersing the following components together with glass beads in a paint shaker for 24 hours.

SDA 1816 (H.W. Sands Co., Ltd.) as a light-heat conversion material—2 parts by weight

Polyester resin as a binder resin (Bairon-200; Toyobou Co., Ltd.)—10 parts by weight

MEK as a solvent—100 parts by weight

Two kinds of liquid, i.e., D1 liquid and D2 liquid, were prepared as a coating liquid for forming the light-transmitting heat-insulating layer.

The D1 liquid was a coating liquid for forming the light-transmitting heat-insulating layer containing no ultraviolet absorbent and was obtained by sufficiently mixing the following components.

Crosslinked styrene-acryl hollow particles dispersion liquid (SX-866 (B): JSR Co., Ltd.) as a light-transmitting heat-insulating material—75 parts by weight

PVA318 as a binder resin—10 parts by weight

Water as a solvent—50 parts by weight

The D2 liquid was a coating liquid for forming the light-transmitting heat-insulating layer containing an ultraviolet absorbent and was obtained by sufficiently mixing the following components.

Crosslinked styrene-acryl hollow particles dispersion liquid (SX-866 (B): JSR Co., Ltd.) as a light-transmitting heat-insulating material—75 parts by weight

PVA318 as a binder resin—10 parts by weight

Water as a solvent—50 parts by weight

Benzophenone-based compound (ULS-700: Ippousha Yushi Industries Co., Ltd.) as an ultraviolet absorbent—20 parts by weight

Two kinds of liquid, i.e., E1 liquid and E2 liquid, were prepared as a coating liquid for forming the protective layer.

The E1 liquid was a coating liquid for forming the protective layer containing no ultraviolet absorbent and was obtained by sufficiently mixing the following components.

Urethane acrylate-based ultraviolet-curing resin (C7-157: Dainihon Ink Co., Ltd.) as resin—15 parts by weight

Ethyl acetate as a solvent—85 parts by weight

The E2 liquid was a coating liquid for forming the protective layer containing an ultraviolet absorbent and was obtained by sufficiently mixing the following components.

PVA318 as resin—15 parts by weight

Benzophenone-based compound (ULS-700: Ippousha Yushi Industries Co., Ltd.) as an ultraviolet absorbent—20 parts by weight

Water as a solvent—85 parts by weight

Next, the examples of the reversible heat-sensitive recording media wherein the aforementioned layers were respectively formed using the aforementioned coating liquids will be explained together with comparative examples.

### Example 1

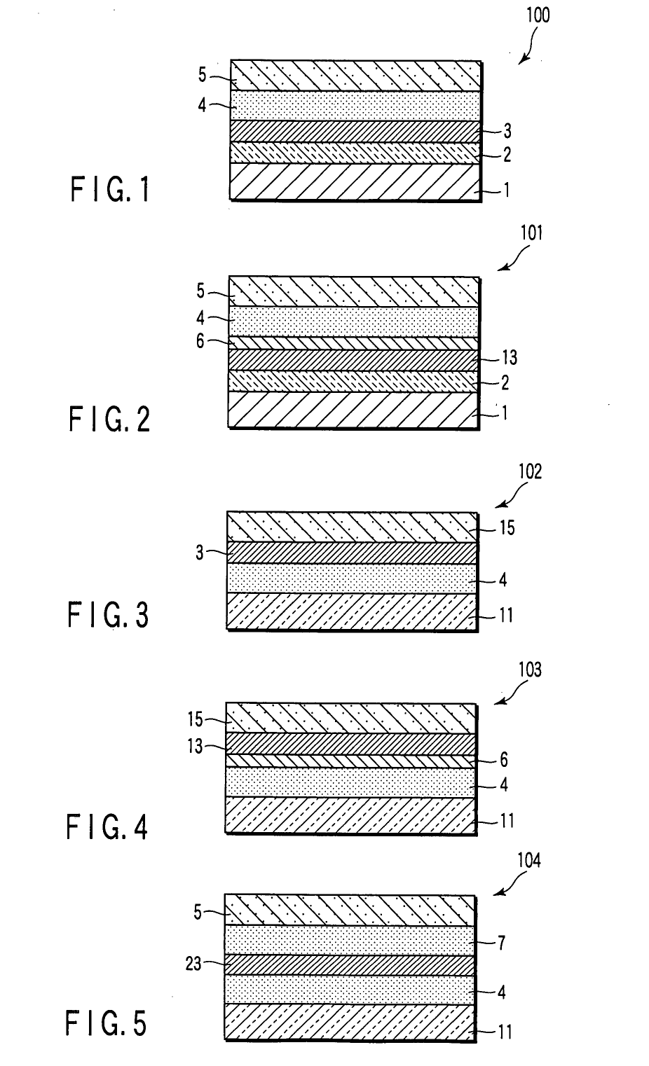

Using wood-free paper as a substrate 1, a reversible heat-sensitive recording medium constructed as shown in FIG. 1 was manufactured. First of all, by a bar coater, the A1 liquid (dry weight: 5 g/m²) was coated on this wood-free paper and dried to form a heat-insulating layer 2. Then, by a bar coater, the B1 liquid (dry weight: 8 g/²) was coated on this heat-insulating layer 2 and dried to form a heat-sensitive reversible layer 3.

Then, by a bar coater, the D1 liquid (dry weight: 5 g/m²) was coated on the heat-sensitive reversible layer 3 and dried to form a light-transmitting heat-insulating layer 4. By a bar coater, the E1 liquid (dry weight: 5 g/m²) was coated on the light-transmitting heat-insulating layer 4 and dried to form a protective layer 5, thus obtaining a reversible heat-sensitive recording medium 100.

### Example 2

Using PET film having a thickness of 180 μm as a substrate 1, a reversible heat-sensitive recording medium constructed as shown in FIG. 1 was manufactured. First of all, by a bar coater, the A2 liquid (dry weight: 5 g/m²) was coated on this PET film and dried to form a heat-insulating layer 2. Thereafter, the procedures of Example 1 were repeated in the same manner to obtain a reversible heat-sensitive recording medium 100.

### Example 3

Using wood-free paper as a substrate 1, a reversible heat-sensitive recording medium constructed as shown in FIG. 2 was manufactured. First of all, by a bar coater, the A1 liquid (dry weight: 5 g/m²) was coated on this wood-free paper and dried to form a heat-insulating layer 2. Then, by a bar coater, the B2 liquid (dry weight: 8 g/m²) was coated on this heat-insulating layer 2 and dried to form a heat-sensitive reversible layer 13.

Then, by a bar coater, the C liquid (dry weight: 3 g/m²) was coated on the heat-sensitive reversible layer 13 and dried to form a light-heat conversion layer 6. By a bar coater, the D1 liquid (dry weight: 5 g/m²) was coated on the light-heat conversion layer 6 and dried to form a light-transmitting heat-insulating layer 4. By a bar coater, the E1 liquid (dry weight: 5 g/m²) was coated on the light-transmitting heat-insulating layer 4 and dried to form a protective layer 5, thus obtaining a reversible heat-sensitive recording medium 101.

### Example 4

Using PET film having a thickness of 180 μm as a substrate 1, a reversible heat-sensitive recording medium constructed as shown in FIG. 2 was manufactured. First of all, by a bar coater, the A2 liquid (dry weight: 5 g/m²) was coated on this PET film and dried to form a heat-insulating layer 2. Thereafter, the procedures of Example 3 were repeated in the same manner to obtain a reversible heat-sensitive recording medium 101.

### Example 5

Using PET film having a thickness of 180 μm as a transparent substrate 1, a reversible heat-sensitive recording medium constructed as shown in FIG. 3 was manufactured. First of all, by a bar coater, the D2 liquid (dry weight: 5 g/m²) was coated on this PET film and dried to form a light-transmitting heat-insulating layer 4. Then, by a bar coater, the B1 liquid (dry weight: 8 g/m²) was coated on the light-transmitting heat-insulating layer 4 and dried to form a heat-sensitive reversible layer 3. By a bar coater, the E2 liquid (dry weight: 5 g/m²) was coated on the heat-sensitive reversible layer 3 and dried to form a protective layer 15, thus obtaining a reversible heat-sensitive recording medium 102.

### Example 6

Using PET film having a thickness of 180 μm as a transparent substrate 1, a reversible heat-sensitive recording medium constructed as shown in FIG. 4 was manufactured. First of all, by a bar coater, the D2 liquid (dry weight: 5 g/m²) was coated on this PET film and dried to form a light-transmitting heat-insulating layer 4. Then, by a bar coater, the C liquid (dry weight: 3 g/m³) was coated on the light-transmitting heat-insulating layer 4 and dried to form a light-heat conversion layer 6. By a bar coater, the B2 liquid (dry weight: 8 g/m²) was coated on the light-heat conversion layer 6 and dried to form a heat-sensitive reversible layer 13. By a bar coater, the E2 liquid (dry weight: 5 g/m²) was coated on the heat-sensitive reversible layer 13 and dried to form a protective layer 15, thus obtaining a reversible heat-sensitive recording medium 103.

### Example 7

Using PET film having a thickness of 180 μm as a transparent substrate 1, a reversible heat-sensitive recording medium constructed as shown in FIG. 5 was manufactured. First of all, by a bar coater, the D2 liquid (dry weight: 5 g/m²) was coated on this PET film and dried to form a light-transmitting heat-insulating layer 4. Then, by a bar coater, the B1 liquid (dry weight: 8 g/m²) was coated on the light-transmitting heat-insulating layer 4 and dried to form a heat-sensitive reversible layer 23. By a bar coater, the D2 liquid (dry weight: 5 g/m²) was coated on the heat-sensitive reversible layer 23 and dried to form a second light-transmitting heat-insulating layer 7. By a bar coater, the E2 liquid (dry weight: 5 g/m²) was coated on the second light-transmitting heat-insulating layer 7 and dried to form a protective layer 5, thus obtaining a reversible heat-sensitive recording medium 104.

### Example 8

Using PET film having a thickness of 180 μm as a transparent substrate 1, a reversible heat-sensitive recording medium constructed as shown in FIG. 6 was manufactured. First of all, by a bar coater, the D2 liquid (dry weight: 5 g/m²) was coated on this PET film and dried to form a light-transmitting heat-insulating layer 4. Then, by a bar coater, the C liquid (dry weight: 3 g/m²) was coated on the light-transmitting heat-insulating layer 4 and dried to form a light-heat conversion layer 6.

By a bar coater, the B2 liquid (dry weight: 8 g/m²) was coated on the light-heat conversion layer 6 and dried to form a heat-sensitive reversible layer 13. By a bar coater, the C liquid (dry weight: 3 g/m²) was coated on the heat-sensitive reversible layer 13 and dried to form a second light-heat conversion layer 8. By a bar coater, the D2 liquid (dry weight: 5 g/m²) was coated on this second light-heat conversion layer 8 and dried to form a second light-transmitting heat-insulating layer 7. By a bar coater, the E2 liquid (dry weight: 5 g/m²) was coated on the second light-transmitting heat-insulating layer 7 and dried to form a protective layer 5, thus obtaining a reversible heat-sensitive recording medium 105.

### Example 9

A reversible heat-sensitive recording medium was manufactured by repeating the same procedures of Example 1 except that the hollow particles of light-transmitting heat-insulating material employed in the formation of the light-transmitting heat-insulating layer 4 were changed to Nipol MH5055 having a particle diameter of 0.5 μm (Nippon Zeon Co., Ltd.).

### Comparative Example 1

A reversible heat-sensitive recording medium having a similar structure as that of Example 2 was manufactured by repeating the same procedures of Example 2 except that the light-transmitting heat-insulating layer 4 was not provided.

### Comparative Example 2

A reversible heat-sensitive recording medium having a similar structure as that of Example 5 was manufactured by repeating the same procedures of Example 5 except that the light-transmitting heat-insulating layer 4 was not provided.

### Comparative Example 3

A reversible heat-sensitive recording medium was manufactured by repeating the same procedures of Example 2 except that the hollow particles of light-transmitting heat-insulating material employed in the formation of the light-transmitting heat-insulating layer 4 were changed to SX8782(A) having a particle diameter of 1.1 μm (JSR Co., Ltd.). The particle diameter of the hollow particles employed herein was slightly larger than the absorption wavelength (830 nm) of the light-heat conversion material.

### Comparative Example 4

A reversible heat-sensitive recording medium was manufactured by repeating the same procedures of Example 2 except that the hollow particles of light-transmitting heat-insulating material employed in the formation of the light-transmitting heat-insulating layer 4 were changed to E-1030 having a particle diameter of 4.0 μm (Tohso Silica Co., Ltd.). The particle diameter of the hollow particles employed herein was larger than the absorption wavelength (830 nm) of the light-heat conversion material.

Using these reversible heat-sensitive recording media thus manufactured, an image of vertical lines was depicted by the optical system shown in FIG. 7. The evaluation of these reversible heat-sensitive recording media was made by measuring the feeding speed of the recording medium and the width of line representing the image to be formed.

With the optical system being fixed, the feeding speed of the recording medium was variously changed in the formation of the image. As a result, the line width was caused to change depending on the sensitivity of the recording medium. Accordingly, it was possible to calculate the sensitivity of the reversible heat-sensitive recording medium by measuring the feeding speed of the recording medium that enabled the formation of a prescribed line width.

As for the optical system, a semiconductor laser emitting a wavelength of 808 nm and exhibiting an output of 150 mW was employed. This semiconductor laser was controlled to emit parallel rays by a collimator. The power of this laser beam at the surface of the recording medium was found to be 35 mW as measured at 1/e² distribution. This semiconductor laser was irradiated to one or single surface or opposite surfaces of the light-heat conversion material, thereby forming an image. The configuration of the laser beam at the location of the recording medium was found to be 100 μm in diameter. The line width was measured by a dot analyzer.

Provided that the power of the laser beam is unchanged, the irradiation time at the same position would become shorter as the feeding speed of the recording medium is increased, resulting in decrease of energy to be applied to the recording medium. Since the region of the laser beam which makes it possible to form an image is limited to almost a central portion of the entire range of the laser beam, the width of line to be recorded would become less as the energy is decreased.

If it is possible to form a line having a width of 100 μm using a laser beam having a diameter of 100 μm, it indicates that the laser beam has been effectively utilized up to a power of 1/e². If the sensitivity of the reversible heat-sensitive recording medium is sufficiently high, it would become possible to form a line having a width of 100 μm even if the feeding speed of the recording medium is increased.

In other words, it is possible to evaluate whether or not the sensitivity of the reversible heat-sensitive recording medium has been enhanced by measuring the feeding speed of the recording medium which makes it possible to form a line having a width of 100 μm with a laser beam having a diameter of 100 μm.

The results of the evaluation are shown in Table 1.

TABLE 1

| | | | | Particle | Speed for forming |
|---|---|---|---|---|---|
| | Substrate | Structure | Writing | diameter | a 100 μm wide line |
| Ex. 1 | Paper | Substrate/heat-insul./heat sens. + light-heat./ | One | 0.3 | 64 mm/sec |
| | | light-trans./protect. | side | | |
| Ex. 2 | PET | Substrate/heat-insul./heat sens. + light-heat./ | One | 0.3 | 58 mm/sec |
| | | light-trans./protect. | side | | |
| Ex. 3 | Paper | Substrate/heat-insul./heat sens. + light-heat./ | One | 0.3 | 62 mm/sec |
| | | light-trans./protect. | side | | |
| Ex. 4 | PET | Substrate/heat-insul./heat sens. + light-heat./ | One | 0.3 | 57 mm/sec |
| | | light-trans./protect. | side | | |
| Ex. 5 | PET | Substrate/light-trans./heat sens. + light-heat./ | Opposite | 0.3 | 94 mm/sec |
| | | protect. | sides | | |
| Ex. 6 | PET | Substrate/light-trans./light-heat./ | Opposite | 0.3 | 90 mm/sec |
| | | heat sens./protect. | sides | | |
| Ex. 7 | PET | Substrate/light-trans./heat sens. + light-heat./ | Opposite | 0.3 | 98 mm/sec |
| | | light-trans./protect. | sides | | |
| Ex. 8 | PET | Substrate/light-trans./light-heat./ | Opposite | 0.3 | 102 mm/sec |
| | | heat sens./light-heat./light-trans./protect. | sides | | |
| Ex. 9 | Paper | Substrate/heat-insul./heat sens. + light-heat./ | One | 0.5 | 65 mm/sec |
| | | light-trans./protect. | side | | |
| Comp. | PET | Substrate/heat-insul./heat sens. + light-heat./ | One | — | 48 mm/sec |
| Ex. 1 | | protect. | side | | |
| Comp. | PET | Substrate/heat sens. + light-heat./protect. | One | — | 40 mm/sec |
| Ex. 2 | | | side | | (One side) |
| | | | Opposite | — | 78 mm/sec |
| | | | sides | | (Opposite sides) |
| Comp. | PET | Substrate/heat-insul./heat sens. + light-heat./ | One | 1.1 | 32 mm/sec |
| Ex. 3 | | light-trans./protect. | side | | |
| Comp. | PET | Substrate/heat-insul./heat sens. + light-heat./ | One | 4 | 20 mm/sec |
| Ex. 4 | | light-trans./protect. | side | | |

Example 1 represents a reversible heat-sensitive recording medium having the construction shown in FIG. 1, wherein a light-transmitting heat-insulating layer was attached to the reversible heat-sensitive recording medium of Comparative Example 1. The particle diameter of the hollow particles of the light-transmitting heat-insulating material employed in the formation of the light-transmitting heat-insulating layer was 0.3 μm.

With respect to the feeding speed of the recording medium which enabled the formation of a line having a width of 100 μm, while Comparative Example 1 indicated a speed of 48 mm/sec, Example 1 indicated a speed of 64 mm/sec, thus demonstrating the enhancement of sensitivity as a recording medium. This may be attributed to the fact that a beam of near-infrared rays having a wavelength of 808 nm was enabled to pass through the light-transmitting heat-insulating layer and the heat was insulated by the hollow particles, thus making it possible to effectively utilize the heat that has been released in the prior art.

When the reversible heat-sensitive recording medium of Example 1 is employed, it is possible to effectively convert the given light energy into heat to perform the heat-sensitive recording and to speed up the recording of images.

Example 2 was featured in that the substrate 1 of Example 1 was changed to a PET film. Since the PET film substrate is larger in diffusion of heat as compared with a paper substrate, the speed of forming a line having a width of 100 μm would decrease slightly as compared with Example 1. However, it was still possible to secure a speed of 58 mm/sec in Example 2, which was higher than that of Comparative Example 1, thus indicating the enhancement of sensitivity.

When the reversible heat-sensitive recording medium of Example 2 is employed, it is possible to effectively convert the given light energy into heat to perform the heat-sensitive recording and to speed up the recording of images.

The reversible heat-sensitive recording media of Examples 3 and 4 were both constituted by the structure shown in FIG. 2. The particle diameter of hollow particles of light-transmitting heat-insulating material employed in the light-transmitting heat-insulating layer was 0.3 μm. Wood-free paper was employed as a substrate 1 in Example 3 and PET film was employed as a substrate 1 in Example 4. In the case of Example 3, the light-heat conversion material included in the heat-sensitive reversible layer of the reversible heat-sensitive recording medium of Example 1 was disposed independently as a light-heat conversion layer 6. In the case of Example 4, the light-heat conversion material included in the heat-sensitive reversible layer of the reversible heat-sensitive recording medium of Example 2 was disposed independently as a light-heat conversion layer 6.

While the light-heat conversion material was included in the heat-sensitive reversible layer and hence disposed close to the electron-donating compound or electron-accepting compound in the case of the reversible heat-sensitive recording medium of Example 2, the light-heat conversion material was included in the light-heat conversion layer in Examples 3 and 4. Because of this, the effects obtained in Examples 3 and 4 were somewhat inferior as compared with Example 2. Even so, it was possible to secure a speed of 62 mm/sec in forming a line having a width of 100 μm in Example 3, and a speed of 57 mm/sec in forming a line having a width of 100 μm in Example 4, both speeds being higher than that of Comparative Example 1, thus indicating improvement of sensitivity.

When the reversible heat-sensitive recording media of Examples 3 and 4 are employed, it is possible to effectively convert the given light energy into heat to perform the heat-sensitive recording and to speed up the recording of images.

Example 5 describes a reversible heat-sensitive recording medium which was constructed as shown in FIG. 3, wherein the light-transmitting heat-insulating layer 4 was formed on a transparent substrate 11. The particle diameter of hollow particles of light-transmitting heat-insulating material employed in the light-transmitting heat-insulating layer was 0.3 μm. In the cases of the reversible heat-sensitive recording media of Examples 1-4 and of Comparative Example 1, it was designed that the laser beam was irradiated to the recording medium only from one side of the recording medium, i.e., the protective layer side thereof. In this example however, it was possible to irradiate a laser beam from both sides, i.e., from the protective layer side and from the transparent substrate 11 side.

Ordinarily, it is possible to perform double-side irradiation excluding the irradiation through a heat-insulating layer. When the heat-insulating layer is omitted however, it is impossible to effectively utilize the heat, since the heat diffuses into the PET substrate due to the omission of the heat-insulating layer. For this reason, the light-transmitting heat-insulating layer 4 was disposed and the effects to be derived from this light-transmitting heat-insulating layer 4 would apparent from the comparison between Example 5 and Comparative Example 2. Namely, the speed of forming a line having a width of 100 μm as the laser beam was irradiated through both sides of the recording medium was 78 mm/sec in the case of Comparative Example 1, and 94 mm/sec in the case of Example 1, thus indicating improvement of sensitivity in the case of the recording medium of Example 5. It should be noted that the speed of forming a line having a width of 100 μm in Comparative Example 2, wherein the laser beam was irradiated through only one surface of the recording medium, was 40 mm/sec.

When the reversible heat-sensitive recording medium of Example 5 is employed, it is possible to effectively convert the given light energy into heat to perform the heat-sensitive recording and to speed up the recording of images.

Example 6 describes a reversible heat-sensitive recording medium which was constructed as shown in FIG. 4, wherein the light-heat conversion material included in the heat-sensitive reversible layer of the reversible heat-sensitive recording medium of Example 5 was disposed independently as a light-heat conversion layer. Since the light-heat conversion material was included in the heat-sensitive reversible layer in the case of Example 5, the light-heat conversion material was disposed close to the electron-donating compound or the electron-accepting compound. In Example 6 however, the light-heat conversion material was included in the light-heat conversion layer. Because of this, the effects obtained in Example 6 were somewhat inferior as compared with Example 5. Even so, it was possible to secure a speed of 90 mm/sec in forming a line having a width of 100 μm in Example 6, wherein the recording medium was irradiated through both sides thereof, this line-forming speed being higher than that of Comparative Example 1, i.e., a speed of 78 mm/sec in forming a line having a width of 100 μm, wherein the recording medium was irradiated through both sides thereof, thus indicating improvement of sensitivity in Example 6.

When the reversible heat-sensitive recording medium of Example 6 is employed, it is possible to effectively convert the given light energy into heat to perform the heat-sensitive recording and to speed up the recording of images.

Example 7 describes a reversible heat-sensitive recording medium which was constructed as shown in FIG. 5, wherein the light-transmitting heat-insulating layers 4 and 7 were disposed below and above the heat-sensitive reversible layer 23, respectively. The particle diameter of hollow particles of light-transmitting heat-insulating material employed in the light-transmitting heat-insulating layer was 0.3 μm. In this Example 7, the speed of forming a line having a width of 100 μm, wherein the recording medium was irradiated through both sides thereof, was 98 mm/sec, thus indicating further improvement of sensitivity as compared with Example 5.

When the reversible heat-sensitive recording medium of Example 7 is employed, it is possible to effectively convert the given light energy into heat to perform the heat-sensitive recording and to speed up the recording of images.

Example 8 describes a reversible heat-sensitive recording medium which was constructed as shown in FIG. 6, wherein the heat-sensitive reversible layer 23 of Example 7 was replaced by a heat-sensitive reversible layer 13 containing no light-heat conversion material, and this heat-sensitive reversible layer 13 was sandwiched between a pair of the light-heat conversion layers 6 and 8. The particle diameter of hollow particles of light-transmitting heat-insulating material employed in the light-transmitting heat-insulating layer was 0.3 μm. In this Example 8, the speed of forming a line having a width of 100 μm wherein the recording medium was irradiated through both sides thereof was 103 mm/sec, thus indicating further improvement of sensitivity as compared with Example 7.

When the reversible heat-sensitive recording medium of Example 8 is employed, it is possible to effectively convert the given light energy into heat to perform the heat-sensitive recording and to speed up the recording of images.

Example 9 describes the same reversible heat-sensitive recording medium as that shown in FIG. 1 except that the particle diameter of hollow particles employed as a light-transmitting heat-insulating material for forming the light-transmitting heat-insulating layer 4 was changed to 0.5 μm. Due to an increase of the particle diameter of hollow particles from 0.3 to 0.5 μm, the effect of heat insulation was promoted, thus making it possible to slightly enhance the sensitivity of the recording medium as compared with Example 1. Namely, the speed of forming a line having a width of 100 μm, wherein the recording medium was irradiated through one side thereof, was 65 mm/sec in Example 9.

When the reversible heat-sensitive recording medium of Example 9 is employed, it is possible to effectively convert the given light energy into heat to perform the heat-sensitive recording and to speed up the recording of images.

Comparative Example 3 and Comparative Example 4 describe the same structure as that of Example 2 except that the particle diameter of hollow particles employed as a light-transmitting heat-insulating material for forming the light-transmitting heat-insulating layer 4 was increased to 1.1 and 4 μm, respectively, both diameters being larger than the wavelength of the laser beam to be irradiated. When the samples of Comparative Example 3 and Comparative Example 4 were employed, the sensitivity thereof was decreased on the contrary as compared with Comparative Example 1. The reason for this may be explained such that since hollow particles having a larger particle diameter were employed in these Comparative Examples, the quantity of light passing through the hollow particles was decreased, thus deteriorating the sensitivity of these recording media.

Incidentally, although the absorption wavelength of the light-heat conversion material employed in these Examples and Comparative Examples was limited to 808 nm, it is of course possible to employ other kinds of light-heat conversion material in conformity with wavelength of laser of optical system to be employed. Further, since the laser beam was irradiated to the recording medium through both sides thereof so as to converge the laser beam at the same portion of the recording medium in the image-forming optical system shown in FIG. 7, it was possible to nearly double the sensitivity of the recording medium. Further, even if the laser beam is irradiated to different lines in the sub-scanning direction, it is possible to achieve the recording at a speed which is approximately twice as high as the image-recording speed which can be achieved using only one optical system.

According to the present invention, it is possible to provide a reversible heat-sensitive recording medium which is capable of effectively converting a given light energy into heat in the photothermal recording, thereby making it possible to speed up image-recording and also provide a method of recording an image using such a recording medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reversible heat-sensitive recording medium comprising:
a heat-sensitive portion containing a light-heat conversion material and a heat-sensitive reversible layer, the light-heat conversion material being enabled to absorb light having a specific wavelength and to convert the light into heat energy and the heat-sensitive reversible layer containing an electron-donating coloring compound and an electron-accepting compound and being enabled to change from a decolorized state to a color-developed state and vice versa, depending on difference in heating temperature and/or cooling temperature to be effected after heating; and
a light-transmitting heat-insulating layer disposed to contact the heat-sensitive portion, the light-transmitting heat-insulating layer being capable of transmitting light having the specific wavelength which the light-heat conversion material is enabled to absorb and also capable of insulating the heat to be emitted from the light-heat conversion material.

2. The recording medium according to claim 1, wherein the light-heat conversion material is included in the heat-sensitive reversible layer, and the recording medium further comprising a substrate supporting, directly or via a heat-insulating layer, the heat-sensitive reversible layer.

3. The recording medium according to claim 1, wherein the heat-sensitive portion further comprises a light-heat conversion layer interposed between the heat-sensitive reversible layer and the light-transmitting heat-insulating layer, the light-heat conversion material being included in the light-heat conversion layer, and the recording medium further comprising a substrate supporting, directly or via a heat-insulating layer, the heat-sensitive reversible layer.

4. The recording medium according to claim 1, wherein the light-heat conversion material is included in the heat-sensitive reversible layer, and the recording medium further comprising a light-transmitting substrate supporting the light-transmitting heat-insulating layer.

5. The recording medium according to claim 4, further comprising a second light-transmitting heat-insulating layer deposited on the heat-sensitive reversible layer, the second light-transmitting heat-insulating layer being capable of enabling light having the specific wavelength which the light-heat conversion material is enabled to absorb to transmit therethrough and also capable of insulating heat.

6. The recording medium according to claim 5, wherein the light-transmitting heat-insulating layer and the second light-transmitting heat-insulating layer are both constructed to contain a macromolecular ultraviolet absorbent.

7. The recording medium according to claim 1, wherein the heat-sensitive portion further comprises a light-heat conversion layer interposed between the heat-sensitive reversible layer and the light-transmitting heat-insulating layer, the light-heat conversion material being included in the light-heat conversion layer, and the recording medium further comprising a light-transmitting substrate supporting the light-transmitting heat-insulating layer.

8. The recording medium according to claim 7, further comprising a second light-transmitting heat-insulating layer deposited on the heat-sensitive reversible layer, the second light-transmitting heat-insulating layer being capable of enabling light having the specific wavelength which the light-heat conversion material is enabled to absorb to transmit therethrough and also capable of insulating heat.

9. The recording medium according to claim 8, wherein the light-transmitting heat-insulating layer and the second light-transmitting heat-insulating layer are both constructed to contain a macromolecular ultraviolet absorbent.

10. The recording medium according to claim 8, further comprising a second light-heat conversion layer interposed between the heat-sensitive reversible layer and the second light-transmitting heat-insulating layer, the second light-heat conversion layer containing a light-heat conversion material which is capable of absorbing light having the specific wavelength and converting the light into heat energy.

11. The recording medium according to claim 10, wherein the light-transmitting heat-insulating layer and the second light-transmitting heat-insulating layer are both constructed to contain a macromolecular ultraviolet absorbent.

12. The recording medium according to claim 1, wherein the light-transmitting heat-insulating layer comprises a macromolecular ultraviolet absorbent.

13. A method for recording an image to the reversible heat-sensitive recording medium of claim 5, wherein the recording of the image is effected through irradiation of a laser beam having a specific wavelength to the opposite sides of the recording medium to enable the laser beam to be absorbed and converted by the light-heat conversion material into thermal energy, by which the heat-sensitive reversible layer is caused to develop a color.

14. A method for recording an image to the reversible heat-sensitive recording medium of claim 10, wherein the recording of the image is effected through irradiation of a laser beam having a specific wavelength to the opposite sides of the recording medium to enable the laser beam to be absorbed and converted by the light-heat conversion layer into thermal energy, by which the heat-sensitive reversible layer is caused to develop a color.
